(19) United States
(12) Patent Application Publication
(10) Pub. No.: US 2021/0188134 A1
(43) Pub. Date: Jun. 24, 2021

(54) VEHICLE SEAT ASSEMBLY

(71) Applicant: Lear Corporation, Southfield, MI (US)

(72) Inventors: Curtis HUDSON, Macomb, MI (US); Mark R. KEYSER, Lake Orion, MI (US); Mladen HUMER, West Bloomfield, MI (US)

(21) Appl. No.: 16/720,712

(22) Filed: Dec. 19, 2019

(51) Int. Cl. B60N 2/22; B60N 2/02; B60N 2/225; B60N 2/90

(52) U.S. Cl. CPC B60N 2/2231; B60N 2/0232; B60N 2002/924; B60N 2/919; B60N 2002/0236; B60N 2/2251

(57) ABSTRACT

A vehicle seat assembly and a method of controlling a vehicle seat assembly are provided. The vehicle seat assembly has a seat back frame rotatably connected to a support frame, and a seat back frame positioning assembly connected to the support frame and the seat back frame. The seat back frame positioning assembly has an electric motor, and a worm connected to the motor shaft for rotation. The seat back frame positioning assembly has a reduction gearset with a first gear in meshed engagement with the worm and driving a second gear. The second gear is connected to the support frame. A controller controls the motor such that the motor shaft rotates at a first speed and at a second speed greater than the first speed, with the seat back frame is rotated relative to the support frame in response to rotation of the motor shaft.

### TECHNICAL FIELD

Various embodiments relate to a vehicle seat assembly with an adjustable seat back.

### BACKGROUND

A vehicle seat assembly may be provided with a mechanism for adjustment of the angle of the seat back. Examples of mechanisms may be found in U.S. Pat. Nos. 7,329,200, 7,544,143, 8,294,311, and 9,139,109, and German Patent Publication No. 102014015938.

### SUMMARY

In an embodiment, a vehicle seat assembly is provided with a support frame, and a seat back frame extending from a lower region to an upper region. The lower region of the seat back frame is rotatably connected to the support frame. A seat back frame positioning assembly is connected to the support frame and the seat back frame. The seat back frame positioning assembly has an electric motor with a motor shaft. A worm is connected to the motor shaft for rotation therewith, and the worm has a helix angle of at least six degrees. A reduction gearset has a first gear driving a second gear. The first gear is in meshed engagement with the worm. The second gear is connected to the support frame. A controller is provided to control the motor such that the motor shaft rotates at a first speed and at a second speed greater than the first speed, and the upper region of the seat back frame is rotated relative to the support frame in response to rotation of the motor shaft.

In a further embodiment, a user interface is provided to receive a user input requesting a seat back adjustment of the upper region of the seat back. The controller is in communication with the user interface and the electric motor to control the electric motor to rotate the motor shaft at the first speed in response to the user input.

In an even further embodiment, the controller is in communication with the electric motor to, in response to receiving a signal from an active vehicle system with a sensor, control the electric motor to rotate the motor shaft at the second speed to rotate the upper region of the seat back frame forward relative to the support frame.

In an even yet further embodiment, a speed ratio of the second speed of the motor shaft to the first speed of the motor shaft is ten to one.

In another further embodiment, the seat back frame positioning assembly further includes a housing having a first housing portion mating with a second housing portion. The first housing portion is sized to receive the worm and at least a portion of the gearset. The second housing portion is connected to the electric motor, the first housing portion defining a first aperture sized to receive the worm therethrough.

In an even further embodiment, the first aperture of the first housing portion is defined by a first cylindrical surface. The second housing portion defines a protrusion with a second cylindrical surface. The first and second cylindrical surfaces mate with one another, and are co-axial with an axis of rotation of the motor shaft.

In another even further embodiment, the seat back frame positioning assembly includes a bearing with an inner race and an outer race. The inner race is connected via an interference fit to one of the motor shaft and the worm. The worm is positioned between the bearing and the motor.

In an even yet further embodiment, the first housing portion further defines a second aperture axially aligned with the first aperture, with the second aperture sized to receive and retain the outer race of the bearing.

In a further embodiment, the support frame has a shaft extending across and connected to the support frame, with the second gear connected for rotation with the shaft.

In another further embodiment, the gearset includes a third gear connected for rotation with the first gear. The third gear is in meshed engagement with the second gear.

In an even further embodiment, the first gear, the second gear, and the third gear are each provided as a helical gear. An axis of rotation of the second gear is parallel with an axis of rotation of the first and third gears.

In a further embodiment, the gearset is a planetary gearset.

In another embodiment, a vehicle seat assembly is provided with a support frame, and a seat back frame extending from a lower region to an upper region. The lower region is rotatably connected to the support frame such that the seat back frame rotates about a transverse axis of rotation. A seat back adjustment assembly is connected to the support frame and to the seat back frame. The seat back adjustment assembly has a brushless electric motor with a motor shaft. A worm is connected to the motor shaft for rotation therewith, and the worm has a helix angle of ten degrees or more. A gearset is provided with the seat back adjustment assembly to rotate the seat back frame between a first angular position and a second angular position relative to the support frame.

In a further embodiment, a controller is provided to control the electric motor to rotate the seat back frame in response to receiving a signal indicative of a user request for a seat back position adjustment.

In an even further embodiment, the controller controls the electric motor to rotate the seat back frame in response to receiving a signal indicative of an event from an active vehicle system.

In an even yet further embodiment, the controller controls the electric motor to rotate the motor shaft at a first rotational speed in response to receiving the signal indicative of the user request. The controller controls the electric motor to rotate the motor shaft at a second rotational speed in response to receiving the signal indicative of the event from the active vehicle system. The second rotational speed is greater than the first rotational speed.

In another even yet further embodiment, the controller controls the electric motor to rotate the seat back frame forward by nine to eighteen degrees about the transverse axis of rotation in response to receiving the signal indicative of the event from the active vehicle system.

In an embodiment, a method of controlling a vehicle seat assembly is provided. A seat back frame is provided with a lower region extending to an upper region, and the lower region is connected to a support frame about a transverse axis of rotation. A reduction gearset in a housing is connected to the seat back frame and to the support frame. A worm driven by an electric brushless motor is engaged with the reduction gearset. The worm has a helix angle of at least ten degrees. A bearing is positioned on a distal end of the worm within an aperture defined by the housing. In response to a first signal indicative of an event from an active vehicle system, the electric motor is controlled to rotate the worm such that the seat back frame rotates forward about the transverse axis of rotation.

In a further embodiment, the electric motor is controlled to rotate the worm to rotate the upper region of the seat back frame forward or aft in response to a second signal indicative of a user request for a seat back position adjustment.

In an even further embodiment, the electric motor is controlled to operate at a speed in response to receiving the first signal, and operate at another speed greater than the speed in response to receiving the second signal.

### BRIEF DESCRIPTION OF THE DRAWINGS

FIG. 1 illustrates a schematic perspective view of a vehicle seat assembly according to an embodiment;

FIG. 2 illustrates a front perspective view of a seat back frame positioning assembly for use with the vehicle seat assembly of FIG. 1;

FIG. 3 illustrates an exploded view of the seat back frame positioning assembly of FIG. 2 with a housing;

FIG. 4 illustrates a schematic of a housing for use with the vehicle seat assembly and seat back positioning assembly of FIGS. 1-3.

### DETAILED DESCRIPTION

As required, detailed embodiments of the present disclosure are provided herein; however, it is to be understood that the disclosed embodiments are merely examples and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

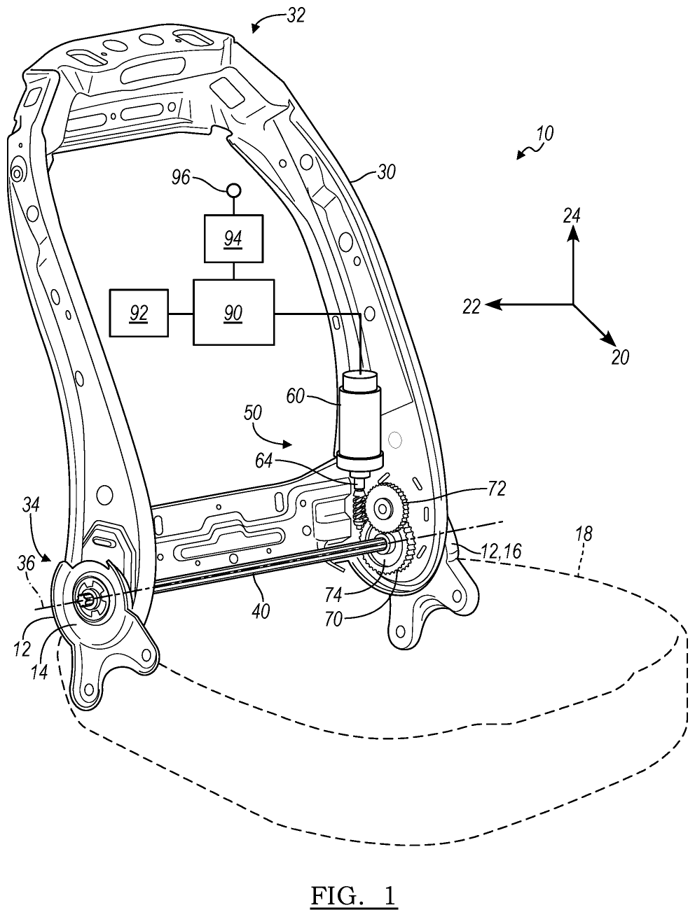

FIG. 1 illustrates a vehicle seat assembly 10. The vehicle seat assembly 10 may be a forward passenger seat assembly or a rear passenger seat assembly, e.g. second row or third row. The vehicle seat assembly 10 has a frame 12, or support frame 12, that is connected to an underlying surface. The underlying surface may be the cabin floor, or may be vehicle seat tracks that are connected to the vehicle floor to allow for the seat 10 to slide forward and rearward in the vehicle.

The support frame 12 has first and second sides 14, 16. The frame supports a seat back frame 30 for rotation relative to the support frame 12. The seat back frame 30 and support frame 12 support cushion and trim elements. The frame 12 also supports a seat pan 18, which may be provided with cushion and trim elements.

The seat back frame 30 may rotate relative to the support frame 12 to allow for adjustment of the seat back angle or recline, and may be connected to the first and second sides of the frame. The seat back frame 30 extends from an upper region 32 to a lower region 34. The lower region 34 of the seat back frame 30 is rotatably connected to the first and second sides 14, 16 of the support frame 12 about a first transverse axis of rotation 36.

With respect to the disclosure, a longitudinal axis 20, a transverse axis 22, and a vertical axis 24 are shown, and may be relative to the installation of the vehicle seat 10 in a vehicle. The axes may be orthogonal to one another. As used herein, the term substantially refers to an angle that is within five degrees of the stated angle or orientation, or within ten degrees of the stated angle or orientation; or within five percent of a dimension such as a length, or within ten percent of a dimension such as a length.

With reference to FIG. 1, the support frame 14 has a torque tube 40 or shaft 40 that is connected to the first and second sides 14, 16. The shaft 40 extends transversely across the seat back frame 30. The shaft 40 may be connected to the first and second sides 14, 16 of the support frame 12 such that is fixed relative to the support frame 12 and does not rotate. In further examples, the shaft 40 may be incorporated into a recline mechanism and only selectively rotated based on a release of the recline mechanism.

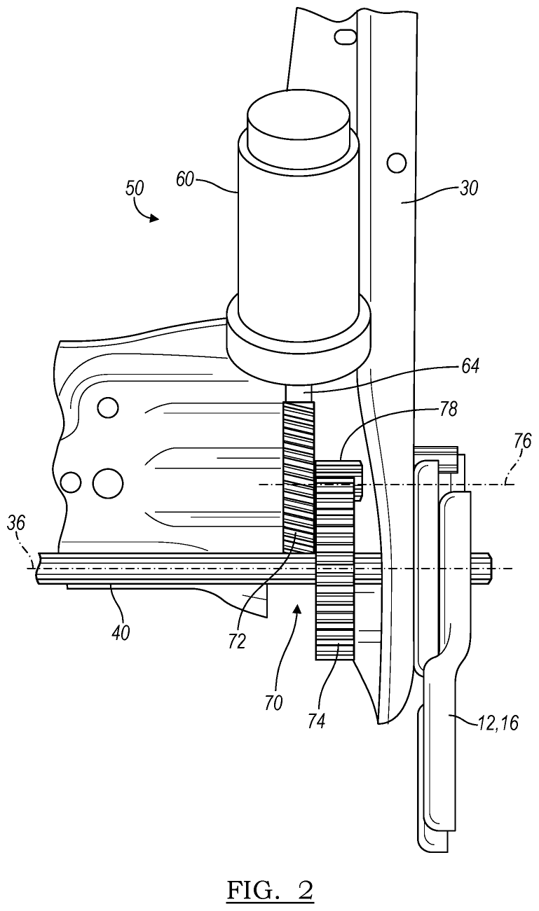

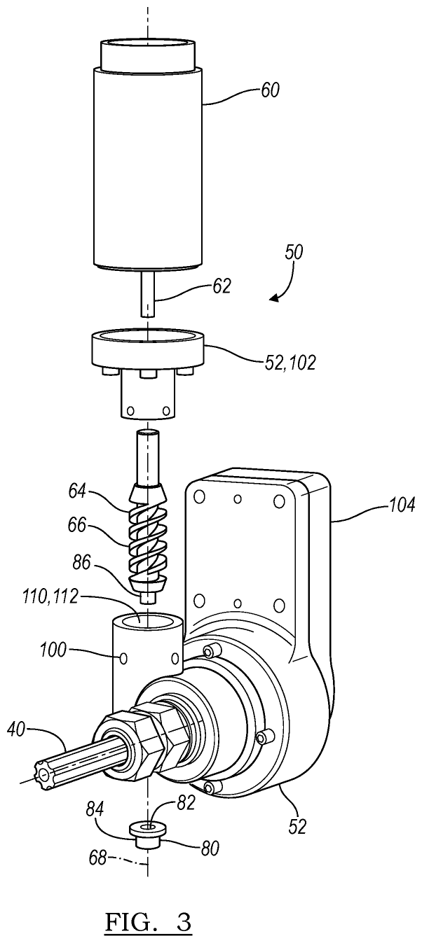

The vehicle seat assembly 10 has a seat back frame positioning assembly 50 connected to the support frame 12 and the seat back frame 30. The assembly 50 is shown in FIGS. 1-2 with the housing omitted. A housing 52 for the assembly 50 is described below with respect to FIG. 3. The assembly 50 is configured to rotate the seat back frame 30 between a first angular position and a second angular position relative to the support frame 12 and about the transverse axis 36.

The assembly 50 has a prime mover 60 such as an electric motor. In various examples, the electric motor 60 is a brushless electric motor. The electric motor 60 has a motor shaft 62. The electric motor 60 may be powered using electrical energy on-board the vehicle, e.g. from a battery. The electric motor 60 may be the sole electric motor 60 provided for the assembly 50 and be configured for both comfort adjustment of the seat back 30 by a user, and rapid repositioning of the seat back 30 based on a vehicle system input or event, as described further below. The electric motor 60 has a low mass, and has a high power output and a range of rotational speeds of the motor shaft 62. By use of a brushless electric motor 60, additional control may be provided with respect to the accuracy of the actuation, speed control, and response time of the motor. Additionally, a brushless motor 60 may have a higher efficiency at high power and speed outputs, as it has a reduced current draw in comparison to a conventional brush motor.

According to one non-limiting example, the motor 60 is controllable to operate at a first, low rotational speed, and a second, high rotational speed. The speed ratio between the second rotational speed and the first rotational speed may be ten to one. The first rotational speed may be 2000-3000 revolutions per minute (rpm). The second rotational speed may be 20,000-25,000 rpm. In other examples, other speeds and speed ratios are also contemplated for the motor.

A worm 64 is provided and is connected to the motor shaft 62. The worm 64 is driven by the motor shaft 62 and rotates with and at the same speed as the motor shaft 62. The worm 64 may be connected to the motor shaft 62 via a spline, keyway, or other similar connection. In other examples, the worm 64 may be connected to the motor shaft 62 via an interference fit. The worm 64 may be spin balanced prior to installation on the motor shaft 62. Spin balancing of the worm 64 may be required based on the second rotational speed of the motor 60.

The worm 64 may have one continuous tooth 66 or thread, and be provided as a helical gear. In other examples, the worm 64 may be multi start, such as 2-start or 3-start with two or three continuous teeth 66 or threads. The worm 64 has a helix angle. The helix angle is the angle between a helix or tooth 66 of the worm 64 and a line perpendicular to the axis of rotation 68 of the worm. The helix angle may be measured in degrees. In one example, the helix angle is at least six degrees. In a further example, the helix angle of the worm 64 is ten degrees or more. As the motor and gearset 70 rotate the shaft, the recliner mechanisms on side supports 14, 16 are actuated to adjust and/or lock the seat back frame 30. Back-driving torque from the seat back frame 30 may occur for example from a load from a seat occupant during a rapid or sudden forward acceleration of the vehicle, e.g. during an event, and may be carried by the recliner mechanisms connected to side supports 14, 16. In one example, the worm 64 is not self-locking, which results in a higher efficiency and the recliner mechanisms connected to the side supports 14, 16 carry the loads. In another example, the worm 64 is selected to be self-locking such that the reduction gearset 70 as described below cannot drive, or back-drive, the worm; and the worm 64 may be self-locking in both a static and dynamic state. For a self-locking worm 64, the assembly 50 can move and/or hold any loads imparted to the assembly by the seat back frame 30, and maintain a position of the seat back frame 30 relative to the support frame 12.

The worm 64 is drivingly connected to a reduction gearset 70. For the reduction gearset 70, a rotational speed of the output shaft is less than a rotational speed of the worm 64 and electric motor 60. The reduction gearset 70 may be a two-stage reduction gearset as shown, or may have another number or stages for reduction. The reduction gearset 70 has a first gear 72 in meshed engagement with the worm 64. The reduction gearset 70 also has a second gear 74 connected to the support frame 12. In the example shown, the second gear 74 is connected to the shaft 40 for rotation with the shaft. The second gear 74 may be connected to the shaft 40 via a spline, keyway, or the like.

In one example, and as shown, the reduction gearset 70 is provided by a worm gear 72 in meshed engagement with and driven by the worm 64. The worm gear 72 may be provided as a worm helical gear, with helical teeth. The worm gear 72 may be provided as the first gear. The worm 64 to worm gear 72 connection may provide the first reduction stage for the gearset 70. The axis of rotation 68 of the worm 64 and the axis of rotation 76 of the worm gear 72 are perpendicular to one another. In a further example, the worm gear 72 may be provided with helical teeth that are broadened on only one side of the worm gear 72, which may further increase the contact area between the worm 64 and worm gear 72, and also provide a more accurate positioning of and control of the worm gear 72 relative to the worm 64.

A pinion 78 may be connected for rotation with the worm gear 72. The pinion 78 may be provided as a third gear in the gearset 70. The worm gear 72 and the pinion 78 may rotate together about a common axis of rotation 76. The worm gear 72 and the pinion 78 may be rotatably connected to a shaft or rod that is connected to the seat back frame, e.g., via the housing 52, such that the worm helical gear and pinion rotate relative to the seat back frame 30.

The pinion 78 is in meshed engagement with a gear 74 such that the pinion 78 drives the gear 74. The gear 74 may be provided as the second gear, and be connected to the shaft 40 via a spline connection or the like. In one example, the pinion 78 and gear 74 are provided as spur gears. In another example, the pinion 78 and gear 74 are provided as helical gears. The axis of rotation 76 of the pinion 78 and the axis of rotation 36 of the gear 74 may be parallel to one another as shown. The pinion 78 to gear 74 connection may provide the second reduction stage for the gearset 70.

In further examples, the reduction gearset 70 may have another number or arrangement of meshed gears, or may be provided by or incorporate a planetary gearset, or the like. For example, the reduction gearset 70 as described above may be provided with an additional meshed pinion and gear to provide a third reduction stage for the gearset.

A bearing 80 is connected to the motor shaft or the worm 64. The bearing 80 may be provided as a ball bearing, a needle bearing, a roller bearing, or the like. The bearing 80 has an inner race 82 and an outer race 84. In the example shown, the inner race 82 of the bearing is connected via an interference fit, or press fit, to the end region 86 of the worm 64. The threaded section of the worm 64 is positioned between the bearing 80 and the motor 60. The outer race 84 of the bearing is received by the housing 52, as described below in further detail. The end region 86 of the worm may have a seat or stepped region formed on it to provide a locating feature for the inner race 82 of the bearing.

A controller 90 is provided and is in communication with the motor 60 to control the motor. The controller 90 may be associated with the vehicle seat assembly 10. The controller 90 may be connected to or in communication with other vehicle or system controllers. The controller 90 may include any number of controllers, and may be integrated into a single controller, or have various modules. Some or all of the controllers may be connected by a controller area network (CAN) or other system. It is recognized that any controller, circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

The controller 90 controls the speed and direction of rotation of the motor shaft 62. The controller 90 controls the motor 60 to control the speed of the motor shaft 62. In one example, the controller 90 controls the motor 60 such that the motor shaft 62 rotates at a first rotational speed and at a second rotational speed. The second rotational speed is greater than the first rotational speed. In one non-limiting example, a speed ratio of the second rotational speed of the motor shaft 62 to the first rotational speed of the motor shaft 62 is ten to one. In other examples, the speed ratio may be greater or less than ten to one. As the motor shaft 62 rotates, the worm 64 is rotated to drive the reduction gearset 70 such that the upper region of the seat back frame is rotated forward or aft relative to the support frame 12, depending on the direction of rotation of the motor shaft 62.

The controller 90 may control the motor 60 to rotate the motor shaft 62 in a first rotational direction or in a second rotational direction. The electric motor shaft 62 rotating in a first direction causes the worm 64 to rotate in the first direction, and move the upper region 32 of the seat back frame 30 forwardly relative to the support frame 12 and relative to the lower region 34 of the seat back frame. The electric motor shaft 62 rotating in a second direction causes the worm 64 to rotate in the second direction, and the upper region 32 of the seat back frame to be moved rearward relative to the support frame 12.

In one example, the controller 90 may control the motor 60 such that the first speed and the second speed are constant values. In another example, the controller may control the motor 60 to a variable speed profile. In a further example, the controller 90 may control the motor 60 such that the motor speeds vary with time and are controlled to a speed profile by controlling a voltage profile of the motor 60, or the voltage-over-time profile delivered by the controller to drive the brushless motor. The voltage profile may increase or decrease over time, and may be a linear or non-linear function. In various examples, the voltage profile is based on variations in occupant stature, the starting angle of seat back, the desired angular seat back travel, and/or the desired seat back travel time. The voltage profile may additionally be varied and controlled such that the angular travel and associated travel times of the seat back differ between a preparatory travel section through a first angular range (e.g. the first nine degrees), and a final travel section through a second angular range (e.g. the second nine degrees). Whether or not the travel should be divided into angular ranges with different voltage profiles may be determined using the vehicle sensor input and various vehicle sensor algorithms. According to one non-limiting example, the motor may be controlled to a profile as described in U.S. patent application Ser. No. 16/394,664 filed Apr. 25, 2019, the contents of which are incorporated by reference in their entirety herein.

By use of a brushless motor, the motor torque and motor speed may be precisely controlled over time, e.g. using the voltage profile. Use of a voltage profile minimizes disturbances or abrupt movements of the seat back for the vehicle seat occupant, while satisfying the seat back travel and speed requirements from either a user interface or vehicle system as described below.

A user interface 92 may be provided and be in communication with the controller 90. The user interface 92 may be provided by buttons or switches on the vehicle seat assembly 10, or may be provided via another vehicle user interface, such as a touch display screen. The user interface 92 receives a user input requesting a seat back adjustment of the upper region 32 of the seat back. The user interface 92 allows a user to request a seat back position adjustment, either forwardly or rearwardly, of the upper region 32 of the seat back frame 30. In a further example, the user input may be stored in memory accessible by the controller 90, for example, within settings associated with a predetermined seat position for a memory vehicle seat assembly.

The user input from the interface 92 provides a first input to the controller 90. In one example, the controller 90 receives a signal indicative of the user input and controls the electric motor 60 to rotate the motor shaft 62 at the first rotational speed in response to the user input, and in either a first or a second rotational direction. In response to receiving an input from the user interface 92 for an adjustment of the upper region 32 of the seat back frame, the controller 90 controls the electric motor 60 to rotate the worm 64 to either move the upper region 32 of the seat back frame forwardly or rearwardly to the desired location and position. The controller 90 may move the seat back frame 30 forwardly or rearwardly between a first angular position and a second angular position, or between any two positions within a range bounded by the first and second positions. In one example, the second position is forward by nine to eighteen degrees of rotation relative to the first position. When the seat back frame 30 reaches the first position or the second position, the controller 90 stops the electric motor 60.

An active vehicle system 94 may also be provided and be in communication with the controller 90. In one example, the vehicle system 94 is an active or dynamic safety system. An active or dynamic vehicle safety system may include various vehicle systems that receive and interpret signals from on-board vehicle sensors 96 to help a driver control the vehicle. Furthermore, the vehicle safety system includes forward- and/or rearward-looking, sensor-based systems such as advanced driver-assistance systems (ADAS). An ADAS may include adaptive cruise control, collision warning, avoidance, and/or mitigation systems, and the like. The ADAS may further include sensors such as cameras, radar, LIDAR, and the like. The vehicle system 94 may provide a signal to the controller 90 when it is activated based on an event, such as a sensor 96 indicating that another vehicle is within a specified proximity of the vehicle or approaching the vehicle at more than a specified rate or speed. In a further example, the signal to the controller 90 is only provided in response to the vehicle system 94 detecting a possible frontal or rear event for the vehicle.

The active vehicle system 94 provides a second input to the controller 90. In one example, the controller 90 receives a signal indicative of an event from the vehicle system 94 and controls the electric motor 60 to rotate the motor shaft 62 at the second rotational speed and in the first direction in response to the input from the vehicle system 94. In response to receiving an input from the vehicle system 94, the controller 90 controls the electric motor 60 to rotate the worm 64 to move the upper region 32 of the seat back frame 30 forwardly from its present position to the second position. In one example, the controller 90 rotates the seat back frame 30 from the first position to the second position. In another example, the controller 90 rotates the seat back frame 30 from an intermediate position to the second position. In a further example and if the seat back frame 30 is already in the second position, the controller 90 maintains the seat back frame 30 in the second position. The input from the vehicle system 94 may be provided by a signal from a sensor 96 associated with the system, or a signal indicative of an event from an active safety system. When the seat back frame 30 reaches the second position, the controller 90 stops the electric motor 60. The forward positioning of the upper region 32 of the seat back frame provides a load path from an occupant of the seat into the seat back frame 30 in the longitudinal direction. In one example, controller 90 may control the electric motor 60 to rotate the seat back frame 30 forward by nine to eighteen degrees of rotation in response to receiving the signal indicative of the event from the vehicle system 94.

In one example, the first speed of the electric motor 60 may provide a forward speed of the seat back frame 30 at the upper edge of the upper region 32 within the range of 15-20 mm/s, and the second speed may be within the range of 150-200 mm/s. In one example, the second speed provides for forward angular movement of the seat back frame 30 by nine to eighteen degrees within approximately 0.5-2 seconds, or in a further example, within 1.0-1.2 seconds

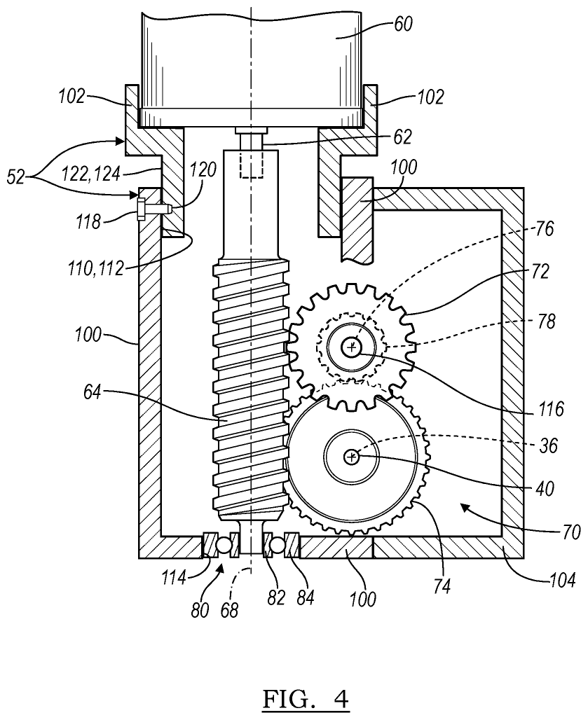

FIGS. 3-4 illustrate a schematic of a housing 52 for use with the assembly. The housing 52 has a first housing portion 100, a second housing portion 102, and a third housing portion 104. In a further example, the first and third housing portions 100, 104 may be integrally formed. The first housing portion 100 mates with the second housing portion 102. The third housing portion 104 also mates with the first housing portion 100 to enclose the reduction gearset 70.

The first housing portion 100 is sized to receive the worm 64 and at least a portion of the gearset 70. The first housing portion 100 defines a first aperture 110 sized to receive the worm 64 therethrough. The first aperture 110 may be defined by a first cylindrical surface 112.

The first housing portion 100 also defines a second aperture 114. The second aperture 114 is sized to receive the outer race 84 of the bearing. In one example, a collet is provided in the first housing portion 100 to retain the outer race 84 of the bearing in the second aperture 114. The collet may be tightened about the outer race 84 of the bearing using a collar, set screw, or the like.

The first and third housing portions 100, 104 may support a shaft 116 for the worm gear 72 and pinion 78. The worm gear 72 and pinion 78 may be supported for rotation on the shaft 116, or may be fixed to the shaft 116, e.g. via a spline connection, with the shaft 116 supported by bearings for rotation relative to the housing portions 100, 104. The first and third housing portions 100, 104 also provide a pair of apertures to accommodate the shaft 40, which is connected to the first and second sides 14, 16 of the support frame 12.

The second housing portion 102 is connected to the electric motor 60. The second housing portion 102 is also connected to the first housing portion 100, for example, using a set screw 118 that aligns with a locating feature 120 and retains the second housing portion 102 to the first housing portion 100. The second housing portion 102 defines a protrusion 122 with an outer cylindrical surface 124. The protrusion 122 may be hollow to circumferentially surround the motor shaft 62 and/or a portion of the worm 64. The second housing portion 102 may be directly connected to the electric motor 60, for example, using a series of fasteners extending through corresponding bolt patterns in the second housing portion 102 and electric motor 60.

The first and second cylindrical surfaces 112, 124 are machined or otherwise formed to mate with one another. The first and second cylindrical surfaces 112, 124 are co-axial with an axis of rotation 68 of the motor shaft 62 and the worm 64. The first and second cylindrical surfaces 112, 124 act to locate the worm 64 relative to the worm gear 72 with a high degree of accuracy, which may be reduce noise when the motor 60 is operating at the high second rotational speed.

The first and second apertures 110, 114 of the first housing portion 100 are axially aligned with one another, and are centered on the rotational axis 68 of the motor shaft 62 and worm 64 when the housing 52 is assembled.

Various examples according to the present disclosure provide for a method of assembling and/or controlling a vehicle seat assembly. The method may be used to control the vehicle seat assembly 10 of FIG. 1 according to various embodiments. The method may be implemented by a controller such as the controller in FIG. 1. In other examples, various steps may be omitted, added, rearranged into another order, or performed sequentially or simultaneously.

A seat back frame is provided with a lower region connected to a support frame about a transverse axis of rotation. The seat back frame extending from the lower region to an upper region. A reduction gearset in a housing is connected to the seat back frame and to the support frame. A worm driven by an electric brushless motor is engaged with the reduction gearset. In one example, the worm is formed with a helix angle of at least ten degrees. A bearing is positioned on a distal end of the worm within an aperture defined by the housing.

In response to a first signal indicative of an event from an active vehicle system, the electric motor is controlled to rotate the worm such that the seat back frame rotates about the transverse axis of rotation from a first angular position to a second angular position. In response to a second signal indicative of a user request for a seat back position adjustment, the electric motor is controlled to rotate the worm to rotate the upper region of the seat back frame forward or aft.

The electric motor is controlled to operate at one speed in response to receiving the first signal, and is controlled to operate at another speed greater than the one speed in response to receiving the second signal.

Various embodiments according to the present disclosure have associated advantages over a conventional mechanism for rotational adjustment of the seat back frame 30. In a conventional mechanism, two motors are typically provided to operate at different speeds based on the input to the mechanism. For example, various embodiments according to the present disclosure provide a faster speed of travel for the upper region 32 of the seat back frame 30. Back-driving torque from the seat back frame 30 during an event may be carried by the recliner mechanisms for the vehicle seat assembly. Alternatively, the worm may be self-locking to cancel or offset back-driving torque from the seat back frame 30 during an event. Furthermore the assembly according to the present disclosure may be used with a vehicle system such as ADAS, as well as to adjust the seat pan position by the user via a user interface.

While exemplary embodiments are described above, it is not intended that these embodiments describe all possible forms of the invention and the disclosure. Rather, the words used in the specification are words of description rather than limitation, and it is understood that various changes may be made without departing from the spirit and scope of the invention. Additionally, the features of various implementing embodiments may be combined to form further embodiments of the invention and the disclosure.

What is claimed is:

1. A vehicle seat assembly comprising:
a support frame;
a seat back frame extending from a lower region to an upper region, the lower region of the seat back frame rotatably connected to the support frame; and
a seat back frame positioning assembly connected to the support frame and the seat back frame, the seat back frame positioning assembly including:
an electric motor having a motor shaft;
a worm connected to the motor shaft for rotation therewith, the worm having a helix angle of at least six degrees;
a reduction gearset having a first gear driving a second gear, the first gear in meshed engagement with the worm, and the second gear connected to the support frame, and
a controller to control the motor such that the motor shaft rotates at a first speed and at a second speed greater than the first speed, wherein the upper region of the seat back frame is rotated relative to the support frame in response to rotation of the motor shaft.

2. The vehicle seat assembly of claim 1 further comprising a user interface to receive a user input requesting a seat back adjustment of the upper region of the seat back frame;
wherein the controller is in communication with the user interface and the electric motor to control the electric motor to rotate the motor shaft at the first speed in response to the user input.

3. The vehicle seat assembly of claim 2 wherein the controller is in communication with the electric motor to, in response to receiving a signal from an active vehicle system with a sensor, control the electric motor to rotate the motor shaft at the second speed to rotate the upper region of the seat back frame forward relative to the support frame.

4. The vehicle seat assembly of claim 3 wherein a speed ratio of the second speed of the motor shaft to the first speed of the motor shaft is ten to one.

5. The vehicle seat assembly of claim 1 wherein the seat back frame positioning assembly further includes a housing having a first housing portion mating with a second housing portion, the first housing portion sized to receive the worm and at least a portion of the gearset, and the second housing portion connected to the electric motor, the first housing portion defining a first aperture sized to receive the worm therethrough.

6. The vehicle seat assembly of claim 5 wherein the first aperture of the first housing portion is defined by a first cylindrical surface;
wherein the second housing portion defines a protrusion with a second cylindrical surface; and
wherein the first and second cylindrical surfaces mate with one another, and are co-axial with an axis of rotation of the motor shaft.

7. The vehicle seat assembly of claim 5 wherein the seat back frame positioning assembly includes a bearing with an inner race and an outer race, the inner race connected via an interference fit to one of the motor shaft and the worm, wherein the worm is positioned between the bearing and the motor.

8. The vehicle seat assembly of claim 7 wherein the first housing portion further defines a second aperture axially aligned with the first aperture, the second aperture sized to receive and retain the outer race of the bearing.

9. The vehicle seat assembly of claim 1 wherein the support frame has a shaft extending across and connected to the support frame, the second gear connected for rotation with the shaft.

10. The vehicle seat assembly of claim 1 wherein the gearset includes a third gear connected for rotation with the first gear, the third gear in meshed engagement with the second gear.

11. The vehicle seat assembly of claim 10 wherein the first gear, the second gear, and the third gear are each provided as a helical gear; and
wherein an axis of rotation of the second gear is parallel with an axis of rotation of the first and third gears.

12. The vehicle seat assembly of claim 1 wherein the gearset is a planetary gearset.

13. A vehicle seat assembly comprising:
a support frame;
a seat back frame extending from a lower region to an upper region, the lower region rotatably connected to the support frame such that the seat back frame rotates about a transverse axis of rotation; and
a seat back adjustment assembly connected to the support frame and to the seat back frame, the seat back adjustment assembly including:
a brushless electric motor having a motor shaft,
a worm connected to the motor shaft for rotation therewith, the worm having a helix angle of ten degrees or more, and
a gearset to rotate the seat back frame between a first angular position and a second angular position relative to the support frame.

14. The vehicle seat assembly of claim 13 further comprising a controller to control the electric motor to rotate the seat back frame in response to receiving a signal indicative of a user request for a seat back position adjustment.

15. The vehicle seat assembly of claim 14 wherein the controller controls the electric motor to rotate the seat back frame in response to receiving a signal indicative of an event from an active vehicle system.

16. The vehicle seat assembly of claim 15 wherein the controller controls the electric motor to rotate the motor shaft at a first rotational speed in response to receiving the signal indicative of the user request; and
wherein the controller controls the electric motor to rotate the motor shaft at a second rotational speed in response to receiving the signal indicative of the event from the active vehicle system, the second rotational speed being greater than the first rotational speed.

17. The vehicle seat assembly of claim 15 wherein the controller controls the electric motor to rotate the seat back frame forward by nine to eighteen degrees about the transverse axis of rotation in response to receiving the signal indicative of the event from the active vehicle system.

18. A method of controlling a vehicle seat assembly, the method comprising:
providing a seat back frame with a lower region extending to an upper region, the lower region connected to a support frame about a transverse axis of rotation;
connecting a reduction gearset in a housing to the seat back frame and to the support frame;
engaging a worm driven by an electric brushless motor with the reduction gearset, the worm having a helix angle of at least ten degrees;
positioning a bearing on a distal end of the worm within an aperture defined by the housing; and
in response to a first signal indicative of an event from an active vehicle system, controlling the electric motor to rotate the worm such that the seat back frame rotates forward about the transverse axis of rotation.

19. The method of claim 18 further comprising, in response to a second signal indicative of a user request for a seat back position adjustment, controlling the electric motor to rotate the worm to rotate the upper region of the seat back frame forward or aft.

20. The method of claim 19 wherein the electric motor is controlled to operate at a speed in response to receiving the first signal, and operate at another speed greater than the speed in response to receiving the second signal.
